(19) United States
(12) Patent Application Publication
(10) Pub. No.: US 2025/0391985 A1
(43) Pub. Date: Dec. 25, 2025

(54) De-Coupled Hybridcell System

(71) Applicant: Chance Bonaventura, Las Vegas, NV (US)

(72) Inventor: Chance Bonaventura, Las Vegas, NV (US)

(21) Appl. No.: 18/753,990

(22) Filed: Jun. 25, 2024

(51) Int. Cl. H01M 50/258; H01M 10/42; H01M 10/48; H01M 10/615; H01M 10/6571; H01R 13/22

(52) U.S. Cl. CPC H01M 50/258; H01M 10/4257; H01M 10/482; H01M 10/615; H01M 10/6571; H01R 13/22; H01M 2010/4278

(57) ABSTRACT

Although secondary rechargeable battery technology and microprocessors have become progressively cheaper; a general inefficiency of the implementation and adoption of a Hybrid Cell Battery design is the waste of components (which are relatively “unworn”) at the end of the useful life of the reserve section. Secondary batteries, with hundreds or thousands of charge cycles, are now commonplace, and microprocessors are found cheaply and in abundance; and yet the need for reusing these longer-lived components (i.e. to decrease costs and waste), has not yet been obviated. This invention, which de-couples a hybrid cell into its major components, allows for the straightforward affixation, removal, activation, and monitoring of said components. This decoupling serves many useful purposes; reserve batteries (not yet being activated) have a shelf life exceeding many times that of primary and secondary batteries; therefore, one may store the “reserve section(s)” virtually indefinitely, for use at a moment's notice; with the added benefit of generally having a higher power density.

### BACKGROUND OF THE INVENTION

The state-of-the-art of primary, secondary, and reserve cell batteries is well summarized in the literature and in former patent(s) filed (U.S. Pat. No. 848,224). Excellent details are provided by the Journal of the Electrochemical Society, the proceedings of the Power Source Symposia, and in NASA Conference proceedings. Similarly, connection control, and monitoring of electronic systems (via microprocessor control) is well known in the art.

A simple hybrid cell battery consists of electrically activated reserve cell(s) a microprocessor control segment, and secondary (rechargeable) cell(s). In such a system each component is electronically interconnected. Viz. the rechargeable cell, being interconnected with a microprocessor and reserve sections; which enables the activation, use, storage, and electrical passivation (patent application Ser. No. 17/842,797) of said cells and their remaining energy.

Recently, innovations have been developed which allow for the coupling and controlling of multiple batteries (with a plurality of cells) in a closed system; however, none have incorporated such systems into the activation of reserve cells; nor have they enabled the management, passivation, and ability to physically de-couple depleted or faulty cells and allow for the addition of new reserve cells into a battery system.

What remains deficient is the ability to continue the use of viable components (secondary Cell(s) and/or microprocessor) in a battery after depletion of the reserve cell segment. An ability to de-couple and couple these components from the system will decrease cost and waste affiliated with disposing of otherwise operationally viable components, as well as gain the benefit of increased storage duration of reserve section and decrease the necessary size of the secondary section in some systems. Viz. With the added benefit of allowing for the interchangeability and use of differing designs of reserve sections to meet intended operational characteristics and performance of different systems and/or uses.

### DESCRIPTIONS OF THE DRAWINGS

FIG. 1: Shows the basic configuration of the invention embodying a simple hybrid battery system that has a secondary cell and microprocessor (segment 1), and a single reserve cell (segment 2); of which can be coupled/de-coupled electronically and physically.

FIG. 2: Shows an embodiment of a hybrid battery system consisting of a secondary cell and microprocessor (segment 1) which can be electronically and physically coupled/de-coupled to a plurality of reserve cells (segment 2);

FIG. 3: Shows a partial view of an enlarged multi-cell reserve embodiment (described in FIG. 2) whereby the reserve section contains a plurality of cells that can be activated, passivated, and monitored electronically.

FIG. 4: Shows a section view of the electrical activation and passivation method of the reserve battery accomplished via electronically isolated conductive terminals situated along the battery case & electronically isolated conductive terminals along the current collecting surface.

FIG. 5: FIG. 5 is an exploded view detailing the shape of the helical reserve section.

FIG. 6: Shows an embodiment whereby a reserve battery can be coupled/de-coupled to an electric vehicle to provide recharging of the lithium battery or act as an auxiliary power source.

### THE INVENTION

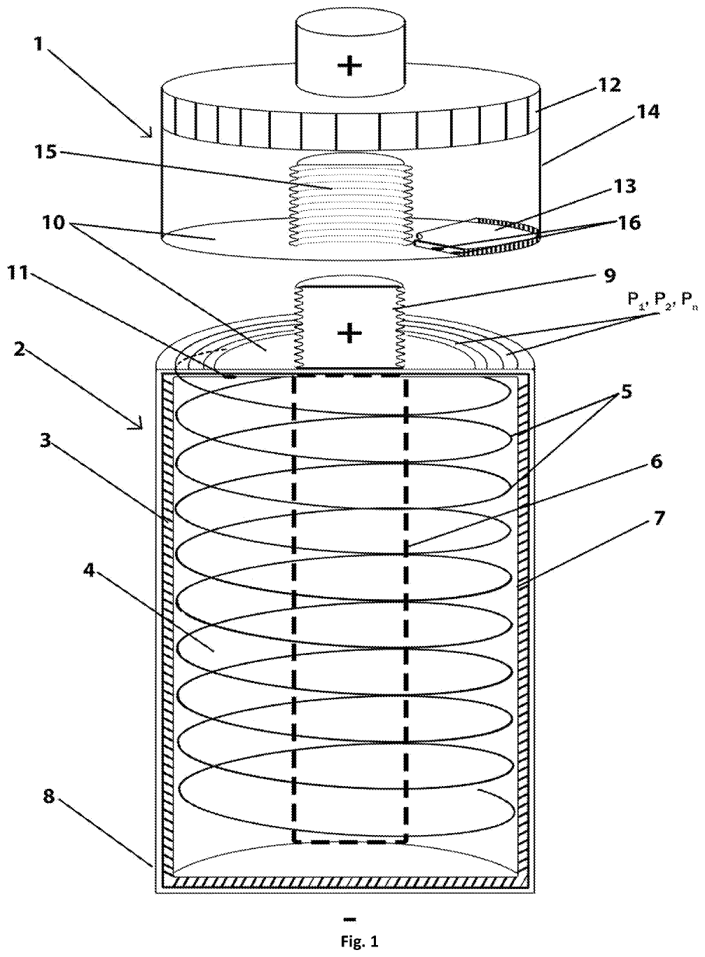

Reference to FIGS. 1,2,3,4,5, and 6 will enable one to understand the invention. FIG. 1, Consists of two main segments: The Second segment (2) consists of, in this embodiment, a rudimentary single-cell Reserve battery constructed of an anode (3), cathode (4) [with electrolyte molecularly bound—to be activated by a heater coil (5)], current collector (6), and separator (7); all of which are contained in a battery case (8). In this embodiment the reserve section has a threaded male connector (9) serving as the positive terminal, and the battery case serving as a ground. Concentric circles of electrically conductive material (P1, P2, P3, Pn) have been added to the mating surface (10), and are electronically isolated from each other and the battery case. These conductive surfaces are electronically interconnected with the heater coil and other desired internal reserve components of the cell [such as pressure and temperature monitoring sensors (11)]. This reserve section can then be mated to segment one (1); which consists of a secondary cell [re-chargeable (12)]) and micro-processor control segment [CPU (13)]; all of which are contained in the secondary battery case (14) and electronically interconnected; which, in this embodiment, is via a threaded (female) connection (15) and a plurality of electrical connectors (16) that match to the electrically conductive concentric rings (P1, Pn) of the reserve segment and threaded male terminal; and thus, upon affixation, result in both sections becoming physically and electrically interconnected.

Note: The microprocesses can be included in the reserve battery case (2) and still be electronically interconnected to the secondary cell via conducting materials (P1,P2,P3,Pn). In an embodiment such as this, as opposed to FIG. 1, segment (1) would only contain a lithium battery, and the CPU would be located within the secondary battery case; of which can be mated to segment 1 to become electronically and physically interconnected (provide power to the CPU). Multiple connector designs and methods may be used, so long as they meet the intended purpose of physical and electronic coupling.

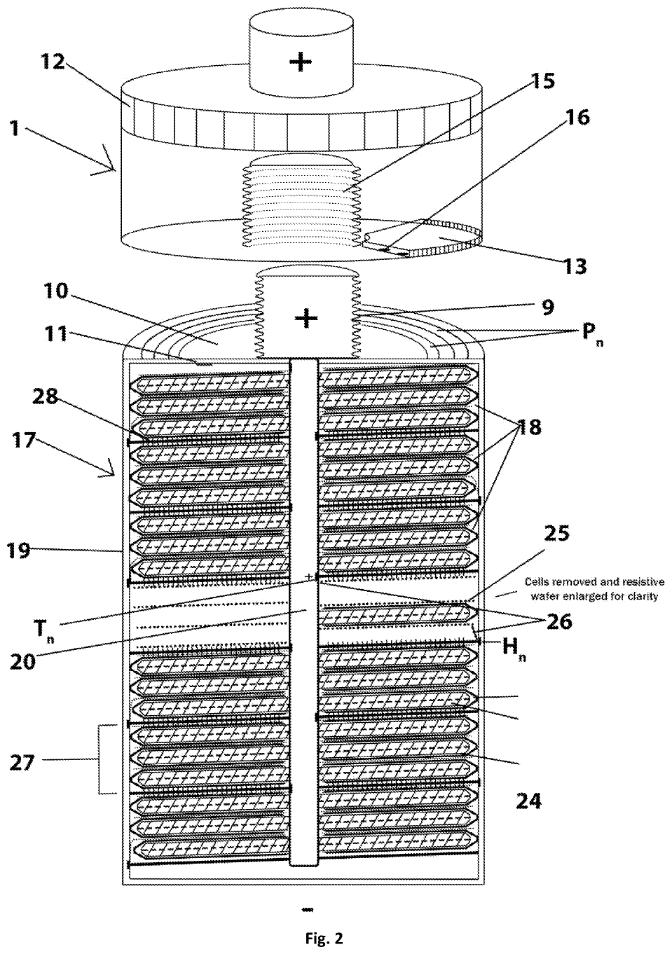

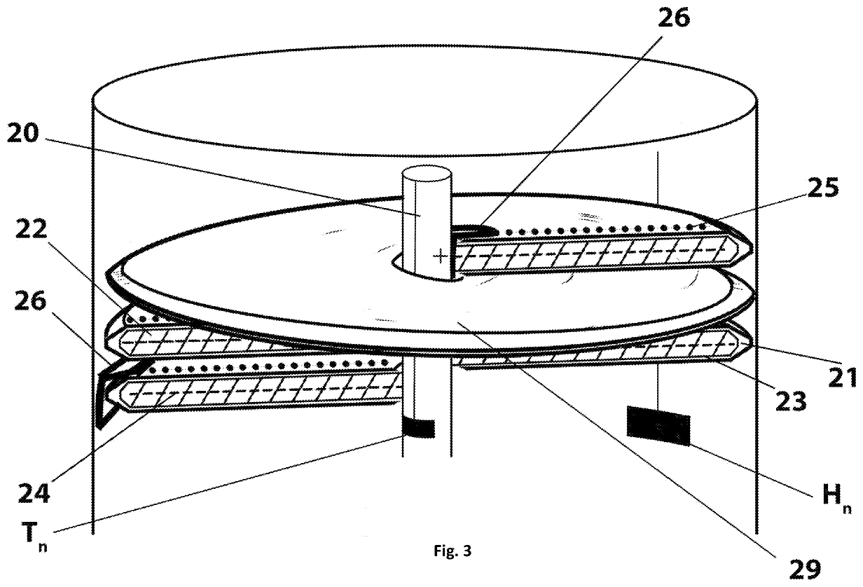

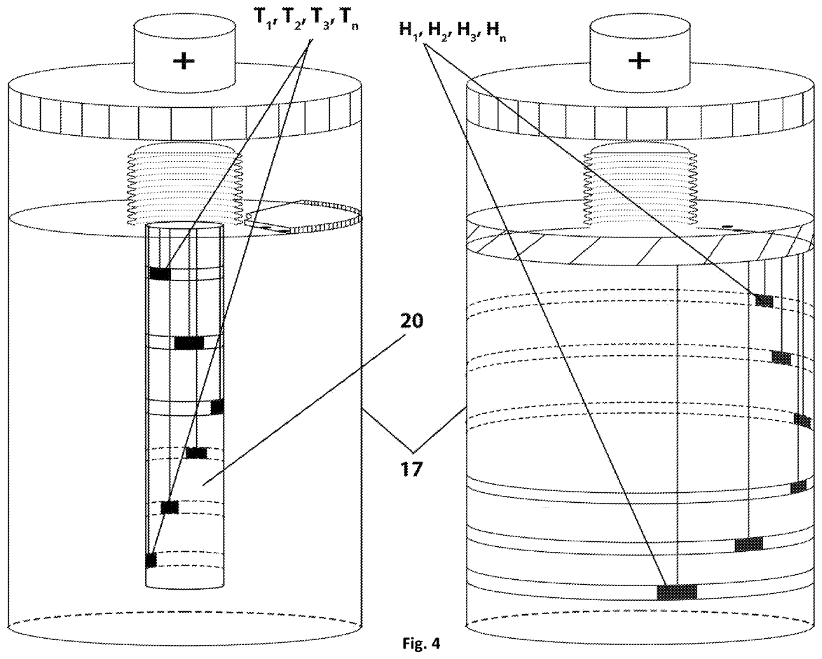

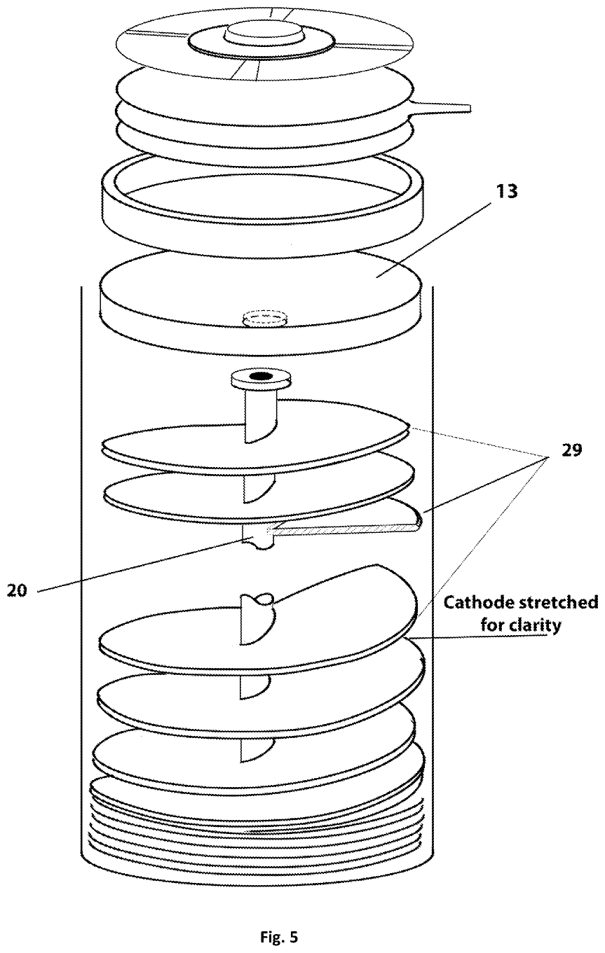

FIGS. 2,3,4,& 5, are an embodiment consisting of two main segments: FIG. 2, consists of a multi-cell reserve battery (17), which in this instance, has a plurality of reserve cells (18) with surfaces situated at an angle in reference to the cylindrical wall of the battery case (19); so as to form—as shown in greater detail in FIG. 5—a contiguous helical shape (29) around the current collecting surface (20), and the cells to be coplanar for each revolution. Each helical battery cell—as shown in greater detail in FIG. 3—consist of an anode (21), cathode (22), separator (23), and current collecting grid (24), and are to be coplanar for each revolution. To achieve activation, each cell has an insulated resistive wafer (25) located between each desired cell revolution, which serves as a heater element (or in alternative embodiments, placed within the cathode if desired). This resistive wafer can be selectively activated singularly or in plurality by completion of a circuit [under microprocessor control (13)]; via—as shown in greater detail in FIG. 5—conductive tabs extending from the resistive surface (26); thus, in this embodiment—and shown in FIG. 4—achieve a completed electrical circuit by mating with isolated electrical contacts serving as the negative terminal [isolated from the battery case—(H1, H2, H3, Hn)] located tangentially along the inner wall of said case, and electrical contacts on the current collecting surface, serving as the positive terminal, [isolated from the current collecting surface—(T1, T2, T3, Tn)]. Once activated each cell section forms a circuit via the contact of the cathode on the positive current collecting surface and contact of the anode on the battery case (thus is the necessity of electronically isolating the circuits needed for the “heater coil”). As shown in FIG. 2, Each cell section (27), depending on desired cell characteristic, is separated with a suitable insulating material (28) and necessary connections are coupled via a threaded male connector (9) serving as the positive terminal, and the battery case serving as a ground. Concentric circles of electrically conductive material (P1, P2, P3, Pn) have been added to the mating surface (10), and are electronically isolated from each other and the battery case. These conductive surfaces are electronically interconnected with the “heater coil” (resistive wafer) and other desired internal reserve components of the cell [such as pressure and temperature monitoring sensors (11)]. This reserve section can then be mated to segment one (1); which consists of a secondary “re-chargeable” cell (12) and micro-processor control segment (13); all of which are contained in the secondary battery case (14); which, in this embodiment, has a threaded (female) connection (15) and a plurality of electrical connectors (16) that match to the electrically conductive concentric rings on the reserve segment and threaded male terminal; and thus, upon affixation, result in both sections becoming physically and electrically interconnected. In varying embodiments, the CPU can be included within the Secondary Battery Case (powered by the secondary battery upon affixation) and connected internally to the necessary components; thus reduce the number of conductive contacts (P1, P2, P3, Pn) needed for desired operation.

Viz. The method of connecting multi-reserve components with secondary cells can be achieved in many different clever ways; however, what is of importance is that the method used, allows for the affixation and removal of both battery segments; while also allowing for the electrical activation, control, monitoring and passivation of the reserve battery.

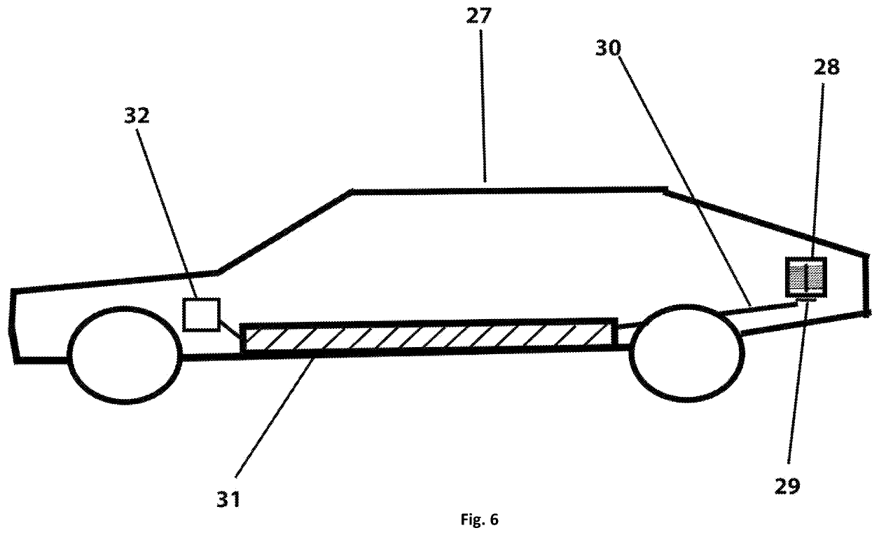

FIG. 6 is an embodiment consisting of a reserve cell (28) which is coupled/de-coupled to a vehicle (27) via electrical contacts connected to the vehicle (30); of which are mated to the electrical contacts on the reserve battery (29); thus, couple the secondary battery (31) and CPU (32), to allow for the activation, passivation, and monitoring of said reserve battery; so as to provide auxiliary and/or emergency power (extended range).

What is claimed:

1: A battery system which consists of two main segments: (1) A Reserve battery that is electronically activated and (2) A Secondary (rechargeable) cell(s), both managed by a Computer Processing Unit; wherein both segments have mechanisms which allow for de-coupling/coupling physically and electronically in order to achieve activation, monitoring, and passivation of the reserve cell(s), recharging of the secondary cell, and powering of the CPU.

2: A battery system as set forth in claim 1 wherein a plurality of reserve cells is physically and electronically coupled or de-coupled to achieve activation, monitoring, passivation of the reserve cells, recharging of the secondary cell(s), and powering of the CPU.

3: A battery system as set forth in claims 1 and 2 wherein reserve cell(s) are selectively activated via a resistive wafer and are contained in the same battery case.

4: A battery system as set forth in claims 1, 2, & 3 wherein a reserve battery utilizes electronically isolated contacts along the current collecting surface & inner battery case; thus, creates a circuit with a resistive material to activate desired reserve cell sections.

5: A battery system as set forth in claims 1, 2, 3, & 4 wherein a secondary battery, reserve battery, & CPU are interconnected via a male & female helical screw connector, and electronic contacts which align with circular electrical contacts (situated around the helical connectors) on either, or both of the battery cases to be mated.

6: A battery system as set forth in claims 1, 2, 3, 4, & 5 wherein a reserve battery is used as an auxiliary power source that is activated, passivated, and monitored electronically via a system (consisting of a CPU & secondary battery) outside of the reserve battery case.

7: A battery system as set forth in claims 1, 2, 3, 4, 5, & 6 wherein a reserve battery with the capability of being coupled/de-coupled electronically & physically, is used in an electronic device or vehicle to provide auxiliary power or recharging of its secondary cells or capacitors.

8: A battery system as set forth in claims 1, 2, 3, 4, 5, 6, & 7 wherein a reserve battery with the capability of being coupled/de-coupled electronically & physically to an electronic system, is used as an emergency power source.
